(19) United States
(12) Patent Application Publication
(10) Pub. No.: US 2009/0264638 A1
(43) Pub. Date: Oct. 22, 2009

(54) METHOD FOR PRODUCING CELLULOSE ACYLATE FILM, CELLULOSE ACYLATE FILM AND OPTICAL FILM

(75) Inventor: Masaaki Otoshi, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/370,300

(22) Filed: Feb. 12, 2009

(30) Foreign Application Priority Data
Feb. 19, 2008 (JP) 2008-037028

(51) Int. Cl. C08B 1/00; B29C 55/02

(52) U.S. Cl. 536/56; 264/291

(57) ABSTRACT

An unstretched cellulose acylate film is stretched in a ratio ranging from 1.05 to 1.6 in the longitudinal direction (MD) in a longitudinal stretching section using at least two rollers having a surface-to-surface separation of 2 to 50 mm therebetween and being different in circumferential velocity, thereafter the cellulose acylate film stretched in the longitudinal direction is heated in the heat treatment section to a temperature ranging from Tc to Tc+80° C. under the conditions that the widthwise ends of the cellulose acylate film are gripped, and thus the cellulose acylate film is contracted in the widthwise direction (TD) to produce the intended cellulose acylate film. This method can provide a cellulose acylate film having properties suitable for an optical film and so on.

This application claims the priority benefit under 35 U.S.C. § 119 of Japanese Patent Application No. 2008-037028 filed on Feb. 19, 2008, which is hereby incorporated in its entirety by reference.

### BACKGROUND OF THE INVENTION

1. Field of the Invention

The present invention relates to a method for producing a cellulose acylate film, a cellulose acylate film and an optical film, in particular, a method for producing a cellulose acylate film for use as a retardation film in a liquid crystal display device, an cellulose acylate film and an optical film.

2. Description of the Related Art

Cellulose acylate films are extending the applications thereof as optical films for use in image display devices such as liquid crystal display devices and organic EL display devices, owing to the transparency, toughness and optical isotropy thereof. As optical films for use in liquid crystal display devices, cellulose acylate films are used as protective films for polarizing plates and additionally as retardation films by developing the in-plane retardation (Re) and thicknesswise retardation (Rth) as a result of stretching.

In these years, retardation films having properties meeting intended applications are demanded, and accordingly, various methods for producing such retardation films have been proposed. For example, a retardation film of 0.5 or less in Rth/Re can be produced by applying a free-end uniaxial stretching to a cellulose acylate film wherein cellulose acylate is heated up to the crystallization temperature thereof, and while the cellulose acylate is being allowed to crystallize, without any constraint imposed on the film in the widthwise direction, the film is stretched in the longitudinal direction (machine direction: MD) (see, for example, Japanese Patent Application Laid-Open Nos. 2003-131033 and 2006-285136).

### SUMMARY OF THE INVENTION

However, the above-described production method needs a long span in the lengthwise direction of the film and no constraint is imposed in the widthwise direction on the film over such a long span, and hence the conveyance of the film becomes unstable. Consequently, there occurs a problem that wrinkles are generated in the lengthwise direction of the film, unevenness is caused in the optical properties and film undergoes undulating distortion. Therefore, there has hitherto been a problem that retardation films having properties such that Rth/Re is 0.5 or less cannot be produced in high quality.

The present invention has been achieved in view of the above-described circumstances, and takes as its object the provision of a method for producing a cellulose acylate film having such properties that the in-plane retardation Re is 100 to 300 nm, the thicknesswise retardation Rth is Re×0.5 or less and the slow axis deviation is ±5° or less in relation to the widthwise direction (transverse direction: TD), a cellulose acylate film and an optical film.

To achieve the above-described object, a method for producing a cellulose acylate film according to an aspect of the present invention includes: forming an unstretched cellulose acylate film; stretching the unstretched cellulose acylate film by a ratio ranging from 1.05 to 1.6 in a longitudinal direction (MD) by using at least two rollers having a surface-to-surface separation ranging from 2 to 50 mm therebetween and being different in circumferential velocity; and contracting in a widthwise direction (TD) the cellulose acylate film stretched in the longitudinal direction, by heating the cellulose acylate film to a temperature ranging from Tc to Tc+80° C. under conditions that widthwise ends of the cellulose acylate film are gripped.

According to the aspect of the present invention, before the unstretched cellulose acylate film is contracted in the widthwise direction (TD) by heating to Tc to Tc+80° C. the unstretched cellulose acylate film while the widthwise ends of the unstretched cellulose acylate film are being gripped, by conducting the stretching in the longitudinal direction (MD) with at least two rollers having a surface-to-surface separation ranging from 2 to 50 mm therebetween and being different in circumferential velocity, Rth can be suppressed to be low and at the same time, Re can be made high, and further, the slow axis deviation in relation to the widthwise direction (TD) can be made small. Additionally, the separation between the two rollers is in a range from 2 to 50 mm at the time of the longitudinal stretching, and hence the film can be made free from optical unevenness (wrinkles and scratches).

In this specification, Tc means the heating crystallization temperature. Additionally, in this specification, an unstretched cellulose acylate film means a cellulose acylate film not yet having been subjected to the longitudinal stretching step and the widthwise contraction step presently disclosed in this specification. Therefore, even if a cellulose acylate film is stretched in the longitudinal direction (MD) because of other reasons in the step of forming a cellulose acylate film, such a film is also referred to as an unstretched cellulose acylate film in this specification.

In the method for producing a cellulose acylate film according to the aspect, in-plane retardation Re and thicknesswise retardation Rth of the cellulose acylate film stretched in the longitudinal direction are 0 to 50 nm and 30 to 100 nm, respectively, and slow axis deviation of the cellulose acylate film contracted in the widthwise direction (TD) is ±5° or less in relation to the widthwise direction (TD).

In the step of stretching in the longitudinal direction, an unstretched cellulose acylate film is stretched in the longitudinal direction (MD) so that the in-plane retardation Re is in a range from 0 to 50 nm and the thicknesswise retardation Rth is in a range from 30 to 100 nm. Thereafter, by conducting contraction in the widthwise direction under the conditions that the temperature is in a range from Tc to Tc+80° C. and the widthwise ends of the cellulose acylate film are gripped, the slow axis deviation can be made to be ±5° or less in relation to the widthwise direction (TD). This specifies the conditions required for the cellulose acylate film stretched in the longitudinal direction in order to attain the slow axis deviation of ±5° or less in relation to the widthwise direction (TD).

In the method for producing a cellulose acylate film according to the aspect, the stretching of the unstretched cellulose acylate film in the longitudinal direction (MD) is conducted at a film temperature in a range from Tg−50° C. or higher to Tg+50° C. or lower.

The stretching of the unstretched cellulose acylate film in the longitudinal direction (MD) at a film temperature ranging from Tg−50° C. to Tg+50° C. causes molecular orientation, and Re can be enhanced after the heat treatment as a step subsequent to the stretching. It is to be noted that in the specification, Tg means the glass transition temperature.

Another aspect of the present invention provides a cellulose acylate film produced by the production method of the present invention.

The cellulose acylate film according to the aspect of the present invention has in-plane retardation Re in a range from 100 to 300 nm, thicknesswise retardation Rth being Re×0.5 or less, and the slow axis deviation being ±5° or less in relation to the widthwise direction (TD).

Further, another aspect of the present invention provides an optical film, in which the cellulose acylate film according to the aspect of the present invention is used.

According to any one of the aspects of the present invention, the unstretched cellulose acylate film is stretched by a ratio ranging from 1.05 to 1.5 in the longitudinal direction (MD) by using at least two rollers having a surface-to-surface separation ranging from 2 to 50 mm therebetween and being different in circumferential velocity, thereafter the cellulose acylate film stretched in the longitudinal direction is contracted in the widthwise direction (TD) by heating the cellulose acylate film to a temperature ranging from Tc to Tc+80° C. under the conditions that the widthwise ends of the cellulose acylate film are gripped. Consequently, it becomes possible to produce a cellulose acylate film having properties that in-plane retardation Re is in a range from 100 to 300 nm, thicknesswise retardation Rth is Re×0.5 or less and slow axis deviation is ±5° or less in relation to the widthwise direction.

### BRIEF DESCRIPTION OF THE DRAWINGS

FIG. 1 is a schematic view illustrating a configuration of a flow-casting film formation line;

FIG. 2 is a schematic view illustrating a configuration of the stretching-heat treatment unit to which the present invention is applied;

FIG. 3 is a plan view illustrating a heat treatment section;

FIG. 4 is an oblique perspective view illustrating a clip;

FIG. 5 is a longitudinal sectional view illustrating the clip;

FIG. 6 is a longitudinal sectional view illustrating a clip having a structure different from the structure shown in FIG. 4;

FIG. 7 is a plan view illustrating a heat treatment section having a structure different from the structure shown in FIG. 2; and

FIG. 8 is a table showing the results of Examples.

### DETAILED DESCRIPTION OF THE PREFERRED EMBODIMENTS

Hereinafter, an embodiment of the method for producing a cellulose acylate film according to the present invention will be described. It is to be noted that although the present invention is described by the below-described preferred embodiment, the present invention can be modified by various methods without deviating from the scope of the present invention, and embodiments other than the present embodiment can be utilized. Accordingly, all the modifications within the scope of the present invention are included in the scope of claims for patent in the present invention. Additionally, in the present specification, the numerical range represented by using “to” means a range inclusive of the numerical values before and after “to.”

<Cellulose Acylate Film>

[Moisture Permeability]

The moisture permeability of the cellulose acylate film according to the embodiment at 40° C. and a relative humidity of 90% is preferably 100 to 400 g/(m²·day), and the moisture permeability change of the same cellulose acylate film having been maintained at 60° C. and a relative humidity of 95% for 1000 hours is preferably −100 g/(m²·day) to 10 g/(m²·day). The “moisture permeability” as referred to herein means the mass change (g/(m²·day)) between before and after the following retainment: the opening of a cup containing calcium chloride is sealed with a film, and the whole cup is placed and retained in a sealed vessel for 24 hours under the conditions of 40° C. and a relative humidity of 90%. The moisture permeability increases with the increase of the temperature, and also with increase of the humidity; however, at any adopted temperature and at any adopted humidity, the magnitude correlation of the moisture permeability between films remains invariant. Accordingly, in this description, the value of the above-described mass change at 40° C. and a relative humidity of 90% is adopted as a reference.

The moisture permeability of the cellulose acylate film according to the embodiment is preferably 100 to 400 g/(m²·day), more preferably 120 to 350 g/(m²·day) and furthermore preferably 150 to 300 g/(m²·day).

When a film is retained at 60° C. and a relative humidity of 95% for 1000 hours, the moisture permeabilities before and after the retainment are measured according to the above-described method, and the value obtained by subtracting the moisture permeability before the retainment from the moisture permeability after the retainment is defined as “the moisture permeability change after 1000-hour retainment at 60° C. and a relative humidity of 95%.” The moisture permeability change after 1000-hour retainment at 60° C. and a relative humidity of 95% of the cellulose acylate film according to the embodiment is −100 g/(m²·day) to 10 g/(m²·day), preferably −50 to 5 g/(m²·day) and more preferably −20 to 0 g/(m²·day).

Moreover, because the moisture permeability decreases with the increase of the film thickness and increases with the decrease of the film thickness, a value obtained by dividing by 80 the product between the measured moisture permeability and the measured film thickness is defined in this description, as “the moisture permeability in terms of 80 μm-film-thickness.” The moisture permeability in terms of 80 μm-film-thickness of the cellulose acylate film according to the embodiment is preferably 100 to 420 g/(m²·day), more preferably 150 to 400 g/(m²·day) and furthermore preferably 180 to 350 g/(m²·day).

The use of a cellulose acylate film satisfying the above-described conditions for the moisture permeability enables to provide a polarizing plate excellent in durability against humidity or wet heat, and a highly reliable liquid crystal display device.

[Cellulose Acylate]

The cellulose acylate film according to the embodiment includes a cellulose acylate as the main component polymer. Here, when the cellulose acylate film is composed of a single polymer, “the main component polymer” means the single polymer itself, and when the cellulose acylate film is composed of a plurality of polymers, “the main component polymer” means a polymer having the highest mass fraction of the constituent polymers.

The cellulose acylate used when the cellulose acylate film according to the embodiment is produced, may be a powdery or a granulous. A pelletized product can also be used. The water content of the cellulose acylate is preferably 1.0% by mass or less, more preferably 0.7% by mass or less and most preferably 0.5% by mass or less. The water content is preferably 0.2% by mass or less as the case may be. When the water content of the cellulose acylate falls outside the preferable range, it is preferable to use the cellulose acylate after having been dried by heating or the like. These polymers may be used each alone or in combinations of two or more thereof.

Examples of the cellulose acylate include cellulose acylate compounds and compounds having an acyl-substituted cellulose skeleton obtained by biologically or chemically introducing a functional group into a cellulose as a raw material.

The cellulose acylate means an ester between a cellulose and a carboxylic acid. As the carboxylic acid constituting the ester, more preferable are fatty acids with carbon number ranging from 2 to 22, and most preferable are lower fatty acids with carbon number ranging from 2 to 4.

In the cellulose acylate, all or part of the hydrogen atoms of the hydroxyl groups located at the 2-, 3- and 6-positions of the glucose unit constituting the cellulose are substituted with an acyl group. Examples of the acyl group include acetyl, propionyl, butyryl, isobutyryl, pivaloyl, heptanoyl, hexanoyl, octanoyl, decanoyl, dodecanoyl, tridecanoyl, tetradecanoyl, hexadecanoyl, octadecanoyl, cyclohexanecarbonyl, oleoyl, benzoyl, naphthylcarbonyl and cinnamoyl. The acyl group is preferably acetyl, propionyl, butyryl, dodecanoyl, octadecanoyl, pivaloyl, oleoyl, benzoyl, naphthylcarbonyl and cinnamoyl, and most preferably acetyl, propionyl and butyryl.

The cellulose acylate may be a cellulose acylate obtained by substitution with a plurality of acyl groups; specific examples of such a cellulose acylate include cellulose acetate propionate, cellulose acetate butyrate, cellulose acetate butyrate propionate and cellulose butyrate propionate.

As the cellulose acylate constituting the cellulose acylate film according to the embodiment, particularly preferable is a cellulose acetate having esters with acetic acid, and more preferable is a cellulose acetate having an acetyl substitution degree ranging from 2.70 to 2.87 and most preferably a cellulose acetate having an acetyl substitution degree ranging from 2.80 to 2.86, from the viewpoint of the solubility to solvents. The substitution degree as referred to herein represents the degree of the substitution of the hydrogen atoms of the hydroxyl groups located on the 2-, 3- and 6-positions of the glucose unit constituting the cellulose; and thus, the substitution degree is 3 in the case where the hydrogen atoms of the hydroxyl groups located at the 2-, 3- and 6-positions are substituted.

The fundamental principles of the method for synthesizing cellulose acylate are described in Wood Chemistry by Nobuhiko Migita et al., pp. 180 to 190 (Kyoritsu Shuppan Co., Ltd., 1968). Representative examples of the method for synthesizing cellulose acylate include a liquid phase acylation method which is based on a carboxylic acid anhydride-a carboxylic acid-sulfuric acid catalyst system. Specifically, first, a raw material for cellulose such as cotton linter or wood pulp is pretreated with an appropriate amount of a carboxylic acid such as acetic acid, and then put into an acylation mixed solution, having been beforehand cooled, for esterification to synthesize a complete cellulose acylate (in which the total acyl substitution degree of the 2-, 3- and 6-positions is approximately 3.00). The acylation mixed solution generally includes a carboxylic acid as a solvent, a carboxylic acid anhydride as an esterifying agent and sulfuric acid as a catalyst. The carboxylic acid anhydride is usually used in an amount stoichiometrically excessive in relation to the total amount of the water in the cellulose to react with the anhydride and the water in the system.

Next, water or aqueous acetic acid is added to the system after the completion of the acylation reaction, in order to hydrolyze the excessive carboxylic acid anhydride remaining in the system. Further, an aqueous solution containing a neutralizing agent (e.g., carbonate, acetate, hydroxide or oxide of calcium, magnesium, iron, aluminum or zinc) may also be added in order to partially neutralize the esterification catalyst. Further, the thus obtained complete cellulose acylate is saponified and aged by maintaining the obtained cellulose acylate at 20 to 90° C. in the presence of a small amount of an acylation reaction catalyst (generally, the remaining sulfuric acid) to be converted into a cellulose acylate having an intended acyl substitution degree and an intended polymerization degree. At the time when the intended cellulose acylate is obtained, the catalyst remaining in the system is completely neutralized with the above-described neutralizing agent; or without neutralizing the catalyst, the cellulose acylate solution is put into water or diluted acetic acid (or water or diluted acetic acid is put into the cellulose acylate solution) to separate the cellulose acylate, the cellulose acylate is subjected to washing and a stabilization treatment, and thus the intended cellulose acylate can be obtained.

The polymerization degree of the cellulose acylate is preferably 150 to 500, more preferably 200 to 400 and furthermore preferably 220 to 350, in terms of the viscosity average polymerization degree. The viscosity average polymerization degree can be measured according to the description of the intrinsic viscosity method of Uda et al. (Kazuo Uda and Hideo Saitoh, Journal of the Society of Fiber Science and Technology, Japan, Vol. 18, No. 1, pp. 105 to 120, 1962). The measurement method of the viscosity average polymerization degree is also described in Japanese Patent Application Laid-Open No. 9-95538.

A cellulose acylate having a small amount of lower molecular component is high in average molecular weight (polymerization degree), but the viscosity thereof is lower in value than common cellulose acylates. Such a cellulose acylate having a small amount of lower molecular component can be obtained by removing the lower molecular component from a cellulose acylate synthesized according to an ordinary method. The removal of the lower molecular component can be conducted by washing the cellulose acylate with an appropriate organic solvent. Alternatively, a cellulose acylate having a small amount of lower molecular component can also be obtained synthetically. When a cellulose acylate having a small amount of lower molecular component is synthesized, it is preferable to regulate the amount of the sulfuric acid catalyst in the acylation reaction so as to be 0.5 to 25 parts by mass in relation to 100 parts by mass of the cellulose. Such regulation of the amount of the sulfuric acid catalyst so as to fall within the above-described range enables to synthesize a cellulose acylate preferable from the viewpoint of the molecular weight distribution (uniform in molecular weight distribution). Cotton as raw materials for cellulose esters and the synthesis method of cellulose esters are also described in Journal of Technical Disclosure Laid-Open No. 2001-1745 (issued on Mar. 15, 2001, Japan Institute of Invention and Innovation), pp. 7 to 12.

<Preparation of Cellulose Acylate Film>

The cellulose acylate film according to the embodiment can be prepared from a solution containing a cellulose acylate and various additives by a solution flow-casting film formation method. The solution flow-casting film formation method is described below in detail.

Alternatively, when the melting point of the cellulose acylate film according to the embodiment or the melting point of the mixture composed of the cellulose acylate film and various additives is lower than the decomposition temperatures of these ingredients and higher than the stretching temperature, the cellulose acylate film can be prepared by film-forming on the basis of a melt film formation method. The melt film formation method is described, for example, in Japanese Patent Application Laid-Open No. 2000-352620.

[Cellulose Acylate Solution]

(Solvent)

When the cellulose acylate film according to the embodiment is prepared by the solution flow-casting film formation method, a cellulose acylate solution is prepared. As the main solvent for use in the cellulose acylate solution, used in this preparation, an organic solvent that is a good solvent for the cellulose acylate can be preferably used. As such a solvent, an organic solvent having a boiling point of 80° C. or lower is more preferable from the viewpoint of the reduction of the time and labor required for drying. The boiling point of the organic solvent is furthermore preferably 10 to 80° C. and particularly preferably 20 to 60° C. Alternatively, an organic solvent having a boiling point of 30 to 45° C. can be preferably used as the main solvent, as the case may be.

Examples of such a main solvent include halogenated hydrocarbons, esters, ketones, ethers, alcohols and hydrocarbons, and these may have a branched structure or a cyclic structure. The main solvent may have any two or more functional groups of ester, ketone, ether and alcohol (namely, —O—, —CO—, —COO—, —OH). Further, the hydrogen atoms in the hydrocarbon moieties of these esters, ketones, ethers and alcohols may be substituted with halogen atoms (in particular, fluorine atoms). It is to be noted that when the main solvent is a single solvent, the main solvent for the cellulose acylate used in preparation of the cellulose acylate film according to the embodiment means the single solvent itself, and when the main solvent is composed of a plurality of solvents, the main solvent means the solvent having the highest mass fraction of the constituent solvents.

As the halogenated hydrocarbons, chlorinated hydrocarbons are more preferable; examples of the preferable chlorinated hydrocarbons include dichloromethane and chloroform, and furthermore preferable among these is dichloromethane. Examples of the esters include methyl formate, ethyl formate, methyl acetate and ethyl acetate. Examples of the ketones include acetone and methyl ethyl ketone. Examples of the ethers include diethyl ether, methyl tert-butyl ether, diisopropyl ether, dimethoxymethane, 1,3-dioxolane, 4-methyldioxolane, tetrahydrofuran, methyltetrahydrofuran and 1,4-dioxane. Examples of the alcohols include methanol, ethanol and 2-propanol. Examples of the hydrocarbons include n-pentane, cyclohexane, n-hexane, benzene and toluene.

Examples of the organic solvents used in combination with these main solvents include halogenated hydrocarbons, esters, ketones, ethers, alcohols and hydrocarbons, and these may have a branched structure or a cyclic structure. The organic solvent may have any two or more functional groups of ester, ketone, ether and alcohol (namely, —O—, —CO—, —COO—, —OH). Further, the hydrogen atoms in the hydrocarbon moieties of these esters, ketones, ethers and alcohols may be substituted with halogen atoms (in particular, fluorine atoms).

As the halogenated hydrocarbons, chlorinated hydrocarbons are more preferable; examples of the preferable chlorinated hydrocarbons include dichloromethane and chloroform, and furthermore preferable among these is dichloromethane. Examples of the esters include methyl formate, ethyl formate, propyl formate, pentyl formate, methyl acetate, ethyl acetate and pentyl acetate. Examples of the ketones include acetone, methyl ethyl ketone, diethyl ketone, diisobutyl ketone, cyclopentanone, cyclohexanone and methylcyclohexanone. Examples of the ethers include diethyl ether, methyl tert-butyl ether, diisopropyl ether, dimethoxymethane, dimethoxyethane, 1,4-dioxane, 1,3-dioxolane, 4-methyldioxolane, tetrahydrofuran, methyltetrahydrofuran, anisole and phenetole.

Examples of the alcohols include methanol, ethanol, 1-propanol, 2-propanol, 1-butanol, 2-butanol, tert-butanol, 1-pentanol, 2-methyl-2-butanol, cyclohexanol, 2-fluoroethanol, 2,2,2-trifluoroethanol and 2,2,3,3-tetrafluoro-1-propanol. Examples of the hydrocarbons include n-pentane, cyclohexane, n-hexane, benzene, toluene and xylene. Examples of the organic solvents having two or more types of functional groups include 2-ethoxyethyl acetate, 2-methoxyethanol, 2-butoxyethanol and methyl acetoacetate.

For the cellulose acylate film according to the embodiment, the solvent contains an alcohol or alcohols in an amount of preferably 5 to 30% by mass, more preferably 7 to 25% by mass and furthermore preferably 10 to 20% by mass in the whole solvent, from the viewpoint of the reduction of the load for film peeling from the band.

Below listed are examples of the organic solvent combinations preferably used as the solvent of the cellulose acylate solution for use in preparation of the cellulose acylate film according to the embodiment. However, the combinations adoptable in this embodiment are not limited to these examples. It is to be noted that the numbers representing the mixing ratio are given in terms of parts by mass.
(1) Dichloromethane/methanol/ethanol/butanol=80/10/5/5
(2) Dichloromethane/methanol/ethanol/butanol=80/5/5/10
(3) Dichloromethane/isobutyl alcohol=90/10
(4) Dichloromethane/acetone/methanol/propanol=80/5/5/10
(5) Dichloromethane/methanol/butanol/cyclohexane=80/8/10/2
(6) Dichloromethane/methyl ethyl ketone/methanol/butanol=80/10/5/5
(7) Dichloromethane/butanol=90/10
(8) Dichloromethane/acetone/methyl ethyl ketone/ethanol/ butanol=68/10/10/7/5
(9) Dichloromethane/cyclopentanone/methanol/pentanol=80/2/15/3
(10) Dichloromethane/methyl acetate/ethanol/butanol=70/12/15/3
(11) Dichloromethane/methyl ethyl ketone/methanol/butanol=80/5/5/10
(12) Dichloromethane/methyl ethyl ketone/acetone/methanol/pentanol=50/20/15/5/10
(13) Dichloromethane/1,3-dioxolane/methanol/butanol=70/15/5/10
(14) Dichloromethane/dioxane/acetone/methanol/butanol=75/5/10/5/5
(15) Dichloromethane/acetone/cyclopentanone/ethanol/isobutyl alcohol/cyclohexane=60/18/3/10/7/2
(16) Dichloromethane/methyl ethyl ketone/acetone/isobutyl alcohol=70/10/10/10
(17) Dichloromethane/acetone/ethyl acetate/butanol/hexane=69/10/10/10/1
(18) Dichloromethane/methyl acetate/methanol/isobutyl alcohol=65/15/10/10
(19) Dichloromethane/cyclopentanone/ethanol/butanol=85/7/3/5
(20) Dichloromethane/methanol/butanol=83/15/2
(21) Dichloromethane=100
(22) Acetone/ethanol/butanol=80/15/5
(23) Methyl acetate/acetone/methanol/butanol=75/10/10/5
(24) 1,3-Dioxolane=100
   A detailed description of the case where a non-halogen organic solvents are adopted as the main solvent is found in Journal of Technical Disclosure Laid-Open No. 2001-1745 (issued on Mar. 15, 2001, Japan Institute of Invention and Innovation), and such combinations may be optionally applicable in the embodiment of the present invention.

(Solution Concentration)

The cellulose acylate concentration in the cellulose acylate solution to be prepared is preferably 5 to 40% by mass, more preferably 10 to 30% by mass and most preferably 15 to 30% by mass. The cellulose acylate concentration may be controlled in the stage of dissolving the cellulose acylate in a solvent so as to be set at a predetermined concentration. Alternatively, a solution having a lower concentration (e.g., 4 to 14% by mass) is beforehand prepared, and then may be concentrated, for example, by evaporating the solvent. Yet alternatively, a solution having a higher concentration is beforehand prepared, and then may be diluted. The cellulose acylate concentration may also be diluted by adding an additive or additives to the solution.

(Additives)

The cellulose acylate solution to be used for preparing the cellulose acylate film according to the embodiment may contain various liquid or solid additives according to the intended applications, in the individual preparation steps. Examples of the additives include a plasticizer (a preferable addition amount thereof is 0.01 to 10% by mass in relation to the cellulose acylate; ditto hereinafter), an ultraviolet absorber (0.001 to 1% by mass), a particulate powder having an average particle size of 5 to 3000 nm (0.001 to 1% by mass), a fluorochemical surfactant (0.001 to 1% by mass), a release agent (0.0001 to 1% by mass), a deterioration preventing agent (0.0001 to 1% by mass), an optical anisotropy-controlling agent (0.01 to 10% by mass) and an infrared absorber (0.001 to 1% by mass).

The plasticizer and the optical anisotropy-controlling agent are each an organic compound having a molecular weight of 3000 or less and preferably having both a hydrophobic moiety and a hydrophilic moiety. These compounds are oriented between the cellulose acylate chains, and accordingly modify the retardation values. Additionally, these compounds improve the hydrophobicity of the film, and accordingly can reduce the humidity-dependent variation of the retardation. Concomitant use of the ultraviolet absorber or the infrared absorber also enables to effectively control the wavelength dependence of the retardation. Preferably, all the additives to be used in the cellulose acylate film according to the embodiment are substantially free from sublimation in the drying process.

From the viewpoint of reducing the humidity-dependent variation of the retardation, the larger addition amounts of these additives are the more preferable; however, with the increase of the addition amounts, the following problems tend to be caused: the decrease of the glass transition temperature (Tg) of the cellulose acylate film and the sublimation of the additives in the production steps of the film. Accordingly, when cellulose acetate is more preferably used in the embodiment of the present invention, the amount of each of the additives having a molecular weight of 3000 or less is preferably in a range from 0.01 to 30% by mass, more preferably 2 to 30% by mass and furthermore preferably 5 to 20% by mass in relation to the cellulose acylate.

A plasticizer preferably usable for the cellulose acylate film according to the embodiment is described in Japanese Patent Application Laid-Open No. 2001-151901. An infrared absorber is described in Japanese Patent Application Laid-Open No. 2001-194522. The timing suitable for adding an additive can be appropriately determined according to the type of the additive. The above-described additives are also described in Journal of Technical Disclosure Laid-Open No. 2001-1745 (issued on Mar. 15, 2001, Japan Institute of Invention and Innovation), pp. 16-22.

(Preparation of Cellulose Acylate Solution)

The preparation of the cellulose acylate solution can be conducted, for example, according to the preparation method described in Japanese Patent Application Laid-Open No. 2005-104148, pp. 106 to 120. Specifically, cellulose acylate and a solvent are mixed together under stirring to swell the cellulose acylate, or, cooling, heating or the like is applied as the case may be, and thus the cellulose acylate is dissolved; thereafter, by filtering the solution thus obtained, a cellulose acylate solution can be obtained.

[Flow-casting, Drying]

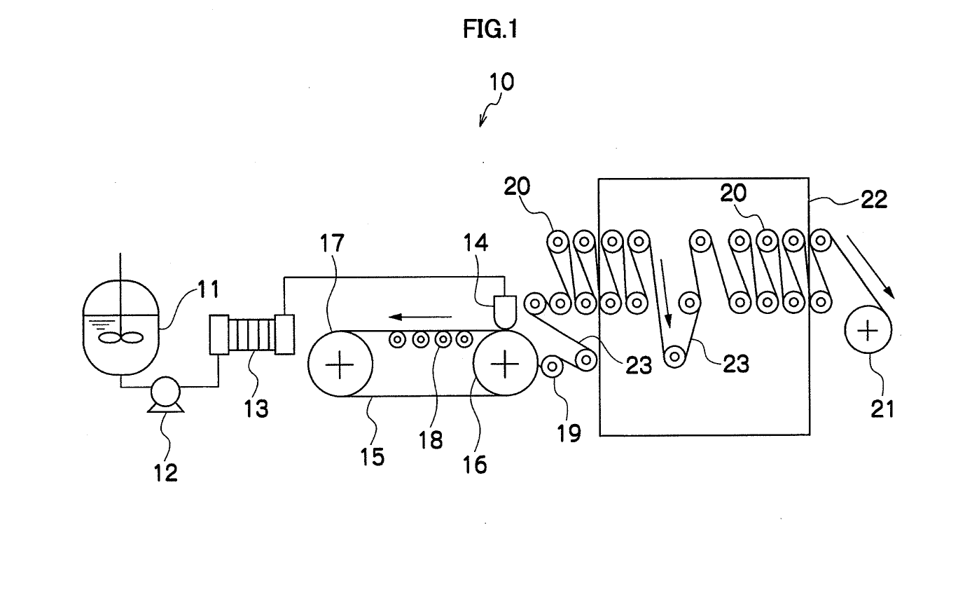

The cellulose acylate film according to the embodiment can be produced in accordance with a conventional solution flow-casting film formation method, by using a conventional solution flow-casting film formation apparatus. FIG. 1 is a schematic view illustrating a flow-casting film formation line 10 for producing a cellulose acylate film according to a solution casting film formation method. A dope (a cellulose acylate solution) prepared in a dissolver (tank) (not shown) is filtered, and then once stored in a storage tank 11, in which the foam contained in the dope is removed and thus, a final dope is prepared. The dope is maintained at 30° C., and transferred to a pressure die 14 from the dope discharge opening, through a pressure-type metering gear pump 12 which is capable of quantitative feeding with high accuracy by controlling rotation speed. A filter 13 can be disposed between the pressure-type metering gear pump 12 and the pressure die 14. The dope is uniformly flow-cast from a pipe sleeve (slit) of the pressure die 14 onto an endlessly-running metal support 15 of the flow-casting section (flow-casting step). Subsequently, at a peeling point at which the metal support 15 has made approximately one round trip, the half-dry dope film (also referred to as a web) is peeled from the metal support 15. Reference numerals 16 and 17 indicate respectively a revolving drum on the flow-casting section side and a revolving drum on the non-flow-casting section side; reference numeral 18 indicates a guide roller and reference numeral 19 indicates a peeling roller. Subsequently, the dope film is conveyed to a drying zone 22. The dope film is conveyed into the drying zone 22 with the aid of guide rollers 20. By conveying the dope film into the drying zone 22, the dope film is dried. On completion of drying, the unstretched cellulose acylate film 23 is wound up with a winding-up unit 21 so as to have a predetermined length. The metal support 15 may be a metal band or a metal belt.

Details of the flow-casting step and the drying step are also described in Japanese Patent Application Laid-Open No. 2005-104148, pp. 120 to 146, and can be appropriately applied to embodiment of the present invention.

On completion of the drying, the residual solvent amount in the film is preferably 0 to 2% by mass and more preferably 0 to 1% by mass. After completion of the drying, the film may be directly conveyed to a heat treatment zone, or may be wound up and then subjected to an off-line heat treatment. Before the heat treatment, the width of the cellulose acylate film is preferably 0.5 to 5 m and more preferably 0.7 to 3 m. When the film is once wound up, the winding-up length is preferably 300 to 30000 m, more preferably 500 to 10000 m and furthermore preferably 1000 to 7000 m.

### [Stretching, Heat Treatment]

Next, description is made on the method in which the cellulose acylate film obtained as described above is stretched in the longitudinal direction (MD), and after the stretching, subjected to a heat treatment for contracting the film in the widthwise direction.

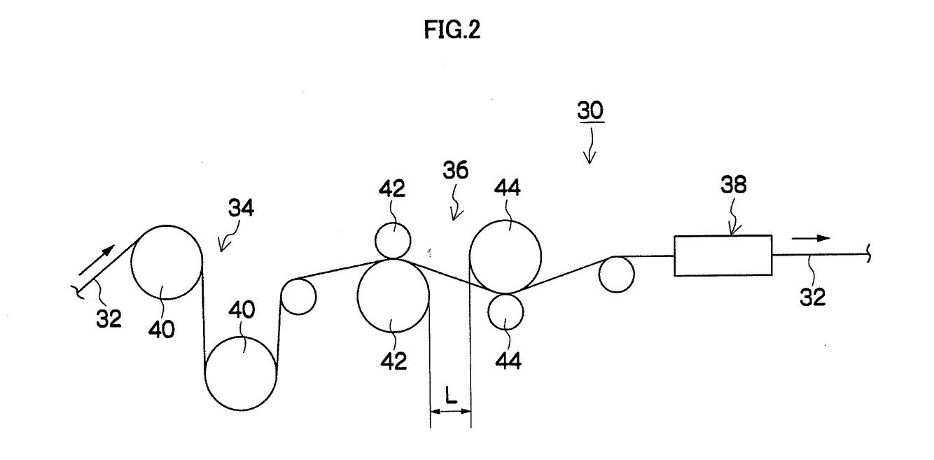

FIG. 2 is a schematic view illustrating the configuration of the stretching-heat treatment unit. As shown in FIG. 2, the stretching-heat treatment unit 30 includes a preheating section 34 for heating an unstretched cellulose acylate film 32, a longitudinal stretching section 36 for stretching the heated film 32 in the longitudinal direction (MD) and a heat treatment section 38 for thermally contracting the longitudinally stretched film 32 in the widthwise direction.

The preheating section 34 is equipped with rollers 40, 40 the surface temperature of each of which is adjustable. By making the film 32 be wrapped around each of the rollers 40, 40, the film 32 is preheated (heated). The preheated film 32 is conveyed to the longitudinal stretching section 36.

The longitudinal stretching section 36 is equipped with a pair of low-speed rollers 42, 42 and a pair of high-speed rollers 44, 44. The film 32 is pinched by the rollers 42, 42 and the rollers 44, 44 to be conveyed. In this conveyance, owing to the speed difference between the low-speed roller 42 and the high-speed roller 44, the film 32 is stretched in the longitudinal direction (MD).

A non-contact heating unit (not shown) is located midway between the low-speed roller 42 and the high-speed roller 44. The heating unit heats the film 32 under stretching. The structure of the heating unit is not particularly limited. The examples of the associated usable heating way and device may include hot air blowing, a far-infrared heater and a near-infrared heater such as a focus heater. The heating unit controls the temperature of the film 32 so as to be in a range from (Tg−50° C.) to (Tg+50° C.).

The surface-to-surface separation L between the low-speed roller 42 and the high-speed roller 44 is preferably in a range from 2 mm to 50 mm. When the separation L is smaller than the above-described range, it may become difficult for the film to pass between the rollers, and the film may tend to be cut. When the separation L is larger than the above-described range, there occurs a possibility that the conveyance of the film 32 becomes unstable, and consequently wrinkles are generated in the lengthwise direction of the film, unevenness is caused in the optical properties and the film undergoes corrugated deformation.

The longitudinal stretching section 36 configured as described above stretches the film 32 in the longitudinal direction (MD). The stretching is preferably conducted in a longitudinal stretching ratio ranging from 1.05 to 1.6. The longitudinal stretching conducted within such a range enables, when the below-described heat treatment is conducted, to produce a cellulose acylate film having properties such that the in-plane retardation Re is in a range from 100 to 300 nm, the thicknesswise retardation Rth is Re×0.5 or less and the slow axis deviation is ±5° or less in relation to the widthwise direction (TD). The film 32 longitudinally stretched in the longitudinal stretching section 36 is delivered to the heat treatment section 38.

The heat treatment section 38 is equipped with a not-shown heating furnace to control the temperature T of the film 32 so as to satisfy the relation (Tc)≦T≦(Tc+80° C.). Here, Tc represents the crystallization temperature, and by controlling the temperature T of the film 32 to fall within the above-described range, the film 32 is crystallized to be thermally contracted in the widthwise direction (TD).

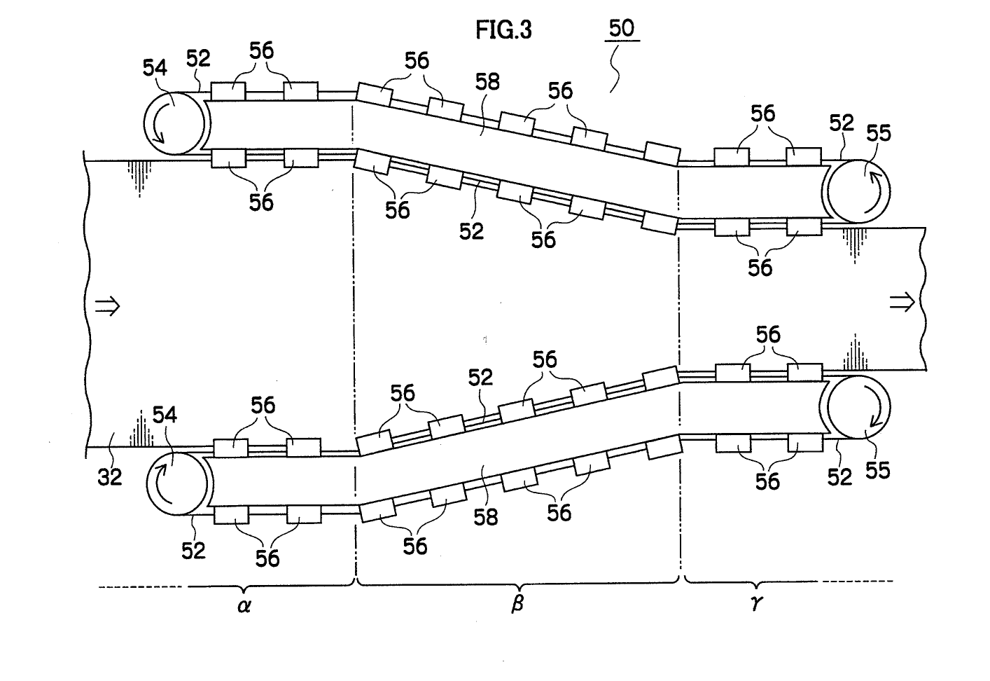

FIG. 3 is a plan view illustrating a heat treatment unit 50 incorporated in the heat treatment section 38. As shown in FIG. 3, the heat treatment unit 50 is equipped with a pair of endless chains 52, 52, and the chains 52, 52 are respectively arranged on the both widthwise ends of the film 32. Each of the chains 52 is wrapped around sprockets 54 (upstream sprockets) and 55(downstream sprockets). By rotating either one of the sprockets 54 and 55 with a not-shown driving unit, the chain 52 is made to revolve.

To each of the pair of chains 52, a plurality of clips 56, 56 . . . are secured at a predetermined pitch. The clip 56 is a member for gripping the widthwise end of the film 32. The clips 56 travel along with the chain 52 so as to revolve between the sprockets 54, 55. A guide rail 58 is arranged between the sprockets 54, 55. The clips 56 traveling between the sprockets 54, 55 are guided by the guide rail 58.

The guide rails 58 are arranged along the both ends in the widthwise direction (TD) of the film 32. The separation between the guide rails 58, 58 is formed so as to change on going from the upstream to the downstream in the conveyance direction (MD) of the film 32. On going from the upstream to the downstream in the conveyance direction of the film 32, the heat treatment unit 50 is provided with a wide region (hereinafter referred to as the heating region) α formed in such a way that the separation between the guide rails 58, 58 is approximately constant (or somewhat extended), a region (hereinafter referred to as the contraction region) β formed so that the separation between the guide rails 58, 58 is gradually decreased, and a region (hereinafter referred to as the retaining region) γ formed so that the separation between the guide rails 58, 58 is narrow and approximately constant. On going from the upstream to the downstream in the conveyance direction (MD) of the film 32, the separation between the guide rails 58, 58 becomes narrow, and the mutual separation between the clips 56, 56 gripping the both ends of the film 32 becomes narrow.

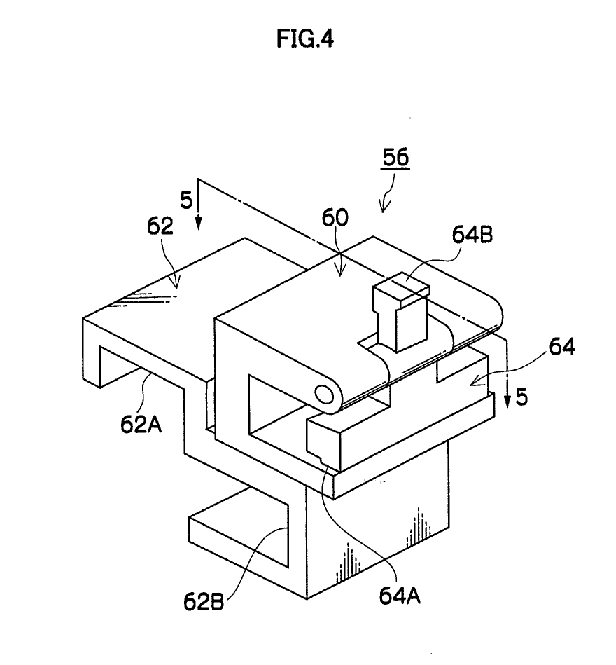

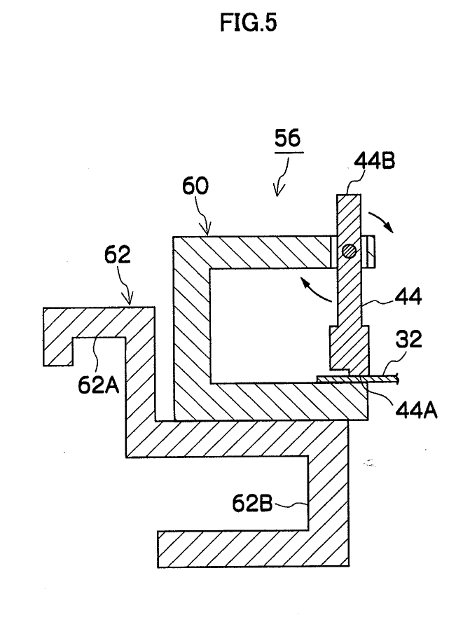

FIG. 4 is an oblique perspective view illustrating the clip 56, and FIG. 5 is a sectional view illustrating the clip 56. As shown in FIGS. 4 and 5, the clip 56 is mainly made up of a main body 60 and a base 62. In the base 62, an attachment section 62A for being attached with the chain 52 and a guide section 62B for being guided by the guide rail 58 are formed, and the base 62 is moved along the guide rail 58 by engaging the guide section 62B with the guide rail 68.

The main body 60 has a flapper 64 supported with a shaft in a freely rotatable manner. The flapper 64 has a pressing member 64A in the lower end thereof, and the end of the film 32 can be gripped by sandwiching the end of the film 32 between the pressing member 64A and the main body 60. A driving lever 64B is formed at the upper end of the flapper 64. By transversely pressing the driving lever 64B with a not-shown guide, the flapper 64 is made to swing. The guide is disposed at the position of each of the sprockets 54, 54. At this position, the flapper 64 is made to swing to allow the switching between gripped condition of the film 32 by the pressing member 64A and the lifting (release) of the gripped condition.

Specifically, configuration and function of each clip 56 are described. The clip 56 grips the end of the film 32 at the position of the upstream sprocket 54 disposed at an upstream position in the conveyance direction of the film 32. The clip 56 is conveyed to the position of the downstream sprocket 55 disposed at a downstream position while the gripped condition is maintained. The clip 56 is formed in such a way that the clip 56 lifts the gripping of the film 32 at the position of the downstream sprocket 55. Consequently, the both ends of the film 32 are gripped at the positions of the upstream sprockets 54 and the gripping of the both ends of the film 32 is lifted at the positions of the downstream sprockets 55.

The contraction region β shown in FIG. 3 is formed so that when the film 32 is contracted in the widthwise direction, by gripping the ends of the film 32 with the clips 56, “the film 32 is prevented from sagging and the ends of the film 32 are not excessively pulled outwardly.” Specifically, the orbit of the clips 56 ensuring that “the film 32 is free from widthwise sagging and the film 32 is not excessively pulled outwardly” is beforehand determined on the basis of a test or the like, and the guide rails 58 are arranged so that the clips 56 travel according to the thus determined orbit.

The condition that “the film 32 is free from widthwise sagging and the film 32 is not excessively pulled outwardly” can be determined by detecting the height position of the widthwise central portion of the film 32 with a device such as a light sensor. In other words, the height position of the central portion for the case where the film 32 sags and the height position of the central portion for the case where the film 32 is excessively pulled outwardly by the clips 56 are beforehand measured, and the orbit of the clips 56 is set so that the height position of the central portion falls intermediate between these two height positions.

According to the heat treatment section 38 formed as described above, by being heated to the vicinity of the crystallization temperature, the film 32 is thermally contracted in the widthwise direction while being allowed to crystallize. In this case, the clips 56 grip the widthwise ends of the film 32, and hence the end of the film 32 can be prevented from behaving as a free end. The film 32 can be prevented from such corrugated plate-like deformation as hitherto seen and such generation of the unevenness in the optical properties as hitherto seen. In the present embodiment, the film 32 is not excessively pulled outwardly by the clips 56, and hence the film 32 is spontaneously thermally contracted by crystallization. Accordingly, the generation of the unevenness in the optical properties as occurring in outward pulling can be prevented.

In the above-described embodiment, by beforehand appropriately setting the width between the guide rails 58, 58 in the contraction region β, “the film 32 is free from sagging and is not excessively pulled outwardly.” However, the method concerned is not limited to the above-described method.

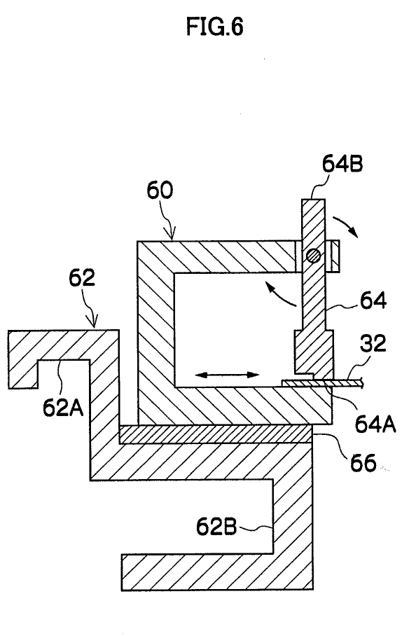

For example, as shown in FIG. 6, by assembling the main body 60 and the base 62 through the intermediary of a rail 66, the main body 60 may be supported so as to be freely slidable in the widthwise direction of the film 32 in relation to the base 62. Herewith, in the contraction region β, the main body 60 is pulled by the film 32 to move when the film 32 is thermally contracted, and hence the film 32 can be prevented from being excessively pulled by the clips 56. By setting in such a way that a predetermined friction is exerted to between the main body 60 and the base 62, the clips 56 can prevent the ends of the film 32 from behaving as a free end, and the generation of the wrinkles and the unevenness of the optical properties in the film 32 can be prevented.

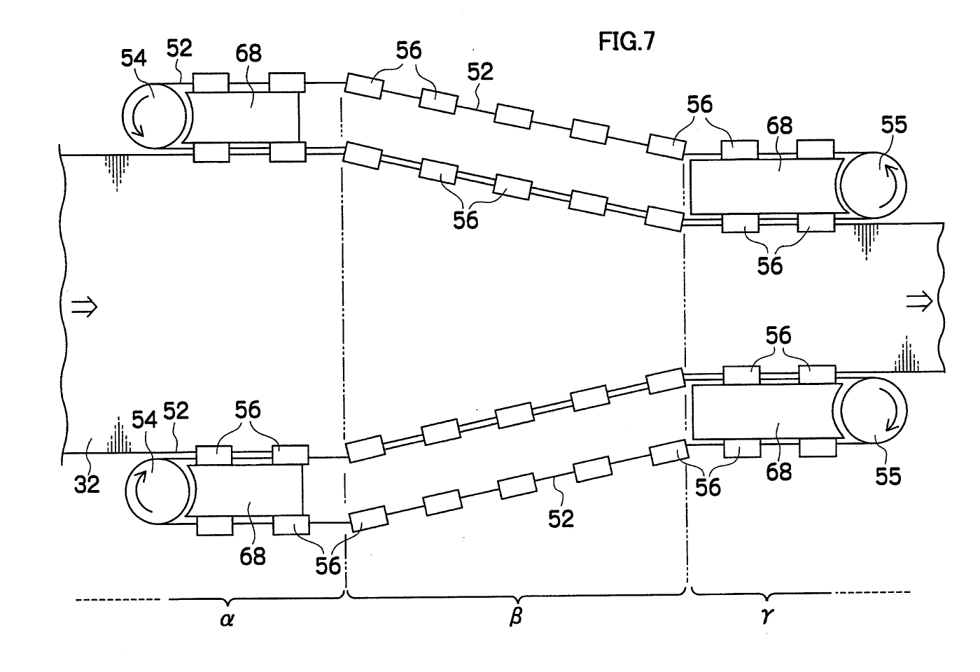

Alternatively, the heat treatment section may also be formed as shown in FIG. 7. The heat treatment section shown in FIG. 7 has a structure in which each of the guide rails 68, 68 is arranged separately in the heating region α and the retaining region y, but no guide rails are arranged in the contraction region β. Accordingly, the clip 56 can move in the contraction region β freely in the widthwise direction, and the film 32 can be prevented from being excessively pulled outwardly by the clips 56. The clips 56 are supported by the chain 52, and hence the clips 56 can prevent the ends of the film 32 from behaving as free ends.

The above-described stretching-heat treatment unit 30 produces a cellulose acylate film 32 having properties such that the in-plane retardation Re is in a range from 100 to 300 nm, the thicknesswise retardation Rth is Re×0.5 or less and the slow axis deviation is ±5° or less in relation to the widthwise direction. In the heat treatment section 38 in the stretching-heat treatment unit 30, the clips 56 grip the both ends of the film 32, and hence the generation of the corrugated plate-like wrinkles and the generation of the unevenness in the optical properties can be prevented, and thus the high-quality cellulose acylate film 32 can be produced.

The above-described cellulose acylate film (hereinafter, the reference numeral is omitted) is preferably of a single layer structure. Here, the “single layer structure” film does not mean a film prepared by bonding a plurality of films or a film having a coating layer on the surface thereof, but means a single sheet of cellulose acylate film, and also includes the case where a single sheet of cellulose acylate film is produced from a plurality of cellulose acylate solutions by applying a successive flow-casting method or a co-flow-casting method. In such a case, by appropriately regulating the types and the mixing amounts of the additives, the molecular weight distribution of cellulose acylate, the type of cellulose acylate and the like, a cellulose acylate film having a thicknesswise distribution can be obtained. Alternatively, examples of the “single layer structure” film include those films each of which includes various functional sections such as an optically anisotropic section, an anti-glare section, a gas barrier section and a damp-resistant section.

[Surface Treatment]

The adhesion of the cellulose acylate films according to the embodiment to each functional layer (e.g., undercoat layer, back layer and optically anisotropic layer) can be improved by appropriately subjecting them to surface treatment. Examples of types of such surface treatment include: the treatment using glow discharge, ultraviolet irradiation, corona, flame, or saponification (acid or alkali saponification), and particularly preferable among these are the treatments using glow discharge or alkali saponification. The “glow discharge treatment” as referred to herein is a treatment in which the film surface is subjected to a plasma treatment in the presence of a plasma-excitatable gas. The details of these surface treatment methods are described in Journal of Technical Disclosure Laid-Open No. 2001-1745 (issued on Mar. 15, 2001, Japan Institute of Invention and Innovation), and such surface treatment methods can be appropriately used.

To improve the adhesion of the film surface to each functional layer, in addition to the surface treatment, or in place of the surface treatment, an undercoat layer (adhesive layer) may also be provided on the cellulose acylate film according to the embodiment. Such undercoat layers are described in Journal of Technical Disclosure Laid-Open No. 2001-1745 (issued on Mar. 15, 2001, Japan Institute of Invention and Innovation), p. 32, and these can be appropriately used. The functional layers provided on the cellulose acylate film according to the embodiment are described in Journal of Technical Disclosure Laid-Open No. 2001-1745 (issued on Mar. 15, 2001, Japan Institute of Invention and Innovation), pp. 32 to 45, and the functional layers described therein can be appropriately used.

<Optical Compensation Film>

The cellulose acylate film according to the embodiment can also be used as an optical compensation film. The “optical compensation film” generally means an optical material that is used in display devices such as liquid crystal display devices and has optical anisotropy, and is synonymous with a retardation film, a retardation plate, an optical compensation film, an optical compensation sheet and the like. In a liquid crystal display device, an optical compensation film is used for the purpose of improving the contrast of the display image, the viewing angle property and the color quality.

The cellulose acylate film according to the embodiment can also be used as it is, as an optical compensation film. Alternatively, Re or Rth is appropriately regulated by laminating a plurality of sheets of the cellulose acylate film according to the embodiment, or by laminating the cellulose acylate film according to the embodiment with films other than the cellulose acylate film according to the embodiment, and such a laminate can also be used as an optical compensation film. The film lamination can be conducted with an adhesive agent or/and tackiness agent.

Alternatively, as the case may be, the cellulose acylate film according to the embodiment is used as a support for an optical compensation film, an optically anisotropic layer composed of a material such as a liquid crystal is disposed thereon, and the laminate thus obtained can also be used as an optical compensation film. The optically anisotropic layer applied to the optical compensation film according to the embodiment may be formed from a composition containing a liquid crystalline compound, or may be formed from a cellulose acylate film having birefringence.

As the liquid crystalline compound, a discotic crystalline compound or a rod-shaped liquid crystalline compound is preferable.

[Discotic Liquid Crystalline Compounds]

Examples of the discotic liquid crystalline compounds usable in the embodiment as the liquid crystalline compounds include the compounds described in various documents (e.g., C. Destrade et al., Mol. Cryst. Liq. Cryst., Vol. 71, p. 111 (1981); Kikan Kagaku Sosetsu (Survey of Chemistry, Quarterly), Vol. 22, Chemistry of Liquid Crystal (1994), edited by the Chemical Society of Japan, Chapter 5 and Chapter 10 Section 2; B. Kohne et al., Angew. Chem., Vol. 96, p. 70 (1984); J.-M. Lehn et al., J. Chem. Soc., Chem. Commun., p. 1794 (1985); J. Zhang et al., J. Am. Chem. Soc., Vol. 116, p. 2655 (1994)).

In the optically anisotropic layer, the discotic liquid crystalline molecules are preferably fixed in an orientation state, and most preferably fixed by polymerization reaction. The polymerization of discotic liquid crystalline molecules is described in Japanese Patent Application Laid-Open No. 8-27284. In order to fix the discotic liquid crystalline molecules by polymerization, it is necessary to bond a polymerizable group, as a substitute, to the discotic core of the discotic liquid crystalline molecules. However, when a polymerizable group is bonded directly to the discotic core, it becomes difficult to maintain the orientation state in the polymerization reaction. Thus, a linking group is introduced between the discotic core and the polymerizable group. The discotic liquid crystalline molecules having a polymerizable group are disclosed in Japanese Patent Application Laid-Open No. 2001-4387.

[Rod-shaped Liquid Crystalline Compounds]

Examples of the rod-shaped liquid crystalline compounds usable as the liquid crystalline compounds in the embodiment include: azomethines, azoxys, cyanobiphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolans, and alkenyl cyclohexyl benzonitriles. As the rod-shaped liquid crystalline compounds, in addition to the above-listed low-molecular liquid crystalline compounds, polymer liquid crystal compounds can also be used.

In the optically anisotropic layer, the rod-shaped liquid crystalline molecules are preferably fixed in an orientation state, and most preferably fixed by polymerization reaction. Examples of the polymerizable rod-shaped liquid crystalline compounds usable in the embodiment include the compounds described, for example, in the following documents: Makromol. Chem., vol. 190, p. 2255 (1989); Advanced Materials, Vol. 5, p. 107 (1993); U.S. Pat. Nos. 4,683,327, 5,622,648 and 5,770,107; Pamphlets of International Publication Nos. WO 95/22586, 95/24455, 97/00600, 98/23580 and 98/52905; Japanese Patent Application Laid-Open Nos. 1-272551, 6-16616, 7-110469, 11-80081 and 2001-328973.

(Optically Anisotropic Layer Made up of Polymer Film)

The optically anisotropic layer may also be formed of a polymer film. The polymer film can be formed of a polymer capable of developing optical anisotropy. Examples of the polymer capable of developing optical anisotropy include polyolefins (e.g., polyethylene, polypropylene and norbornene polymers), polycarbonate, polyarylate, polysulfone, polyvinyl alcohol, polymethacrylic acid ester, polyacrylic acid ester and cellulose esters (e.g., cellulose triacetate and cellulose diacetate). As the polymer, copolymers of these polymers or mixtures of these polymers may also be used.

<Polarizing Plate>

The cellulose acylate film or the optical compensation film according to the embodiment can be used as a protective film for a polarizing plate (the polarizing plate according to the embodiment). The polarizing plate according to the embodiment may be made up of a polarizing film and two sheets of polarizing plate protective film (cellulose acylate film) for protecting the both surface of the polarizing film. The cellulose acylate film or the optical compensation film according to the embodiment can be used as a polarizing plate protective film at least for one side. The cellulose acylate film according to the embodiment can be bonded to the polarizing film with an adhesive in a roll-to-roll manner.

When the cellulose acylate film according to the embodiment is used as the polarizing plate protective film, it is preferable to apply the surface treatment (also described in Japanese Patent Application Laid-Open Nos. 6-94915 and 6-118232) to the cellulose acylate film according to the embodiment for hydrophilization. For example, it is preferable to apply the treatment using glow discharge, corona discharge, alkali saponification or the like; in particular, the alkali saponification treatment is most preferably used as the surface treatment.

As the polarizing film, for example, a polarizing film prepared by immersing a polyvinyl alcohol film in an iodine solution and by stretching the immersed film can be used. When the polarizing film prepared by immersing a polyvinyl alcohol film in an iodine solution and by stretching the immersed film, the surface treated side of the cellulose acylate film according to the embodiment can be directly bonded to the both sides of the polarizing film by using an adhesive. In the production method according to the embodiment, it is preferable to bond the cellulose acylate film directly to the polarizing film as described above. As the adhesive, an aqueous solution of polyvinyl alcohol or polyvinyl acetal (e.g., polyvinyl butyral), or a latex of a vinyl polymer (e.g., polybutyl acrylate) can be used. A particularly preferable adhesive is an aqueous solution of a completely saponified polyvinyl alcohol.

In general, in a liquid crystal display device, a liquid crystal cell is provided between two polarizing plates. Therefore, the device has four sheets of the polarizing plate protective film. The cellulose acylate film according to the embodiment can be preferably used as any of these four sheets of the polarizing plate protective film. It is particularly preferable to use the cellulose acylate film according to the embodiment as the outer protective film, of the four sheets of the protective film, which is not disposed between the polarizing film and the liquid crystal layer (liquid crystal cell) in the liquid crystal display device. In this case, a transparent hard coat layer, an anti-glare layer, an antireflection layer and the like may be provided.

<Liquid Crystal Display Device>

The cellulose acylate film, the optical compensation film and the polarizing plate according to the embodiment can be used in liquid-crystal display devices of various display modes. The cellulose acylate film and the optical compensation film according to the embodiment are low in moisture permeability, and the moisture permeability of each of these films is not increased even when these films are exposed to wet heat, and hence the polarizing plate using such films can be prevented from being degraded in polarization degree for a long period of time. Accordingly, a highly reliable liquid crystal display device can be provided.

Hereinafter, liquid crystal modes in which these films are used will be described. The liquid crystal display devices may be any of transmissive-, reflective-, and semi-transmissive-liquid crystal display devices.

### (TN-mode Liquid Crystal Display Devices)

The cellulose acylate film according to the embodiment can be used as a support of the optical compensation film in a TN (Twisted Nematic)-mode liquid crystal display device having a TN-mode liquid crystal cell. TN-mode liquid crystal cells and TN-mode liquid crystal display devices have long been well known. The optical compensation films used in TN-mode liquid crystal display devices are described in Japanese Patent Application Laid-Open Nos. 3-9325, 6-148429, 8-50206 and 9-26572 and additionally, in the papers by Mori et al. (Jpn. J. Appl. Phys., Vol. 36 (1997), p. 143; Jpn. J. Appl. Phys., Vol. 36 (1997), p. 1068).

(STN-mode Liquid Crystal Display Devices)

The cellulose acylate film according to the embodiment may be used as a support of the optical compensation film in an STN (Super-Twisted Nematic)-mode liquid crystal display device having an STN-mode liquid crystal cell. In general, in an STN-mode liquid crystal display device, rod-shaped liquid crystalline molecules in the liquid crystal cell are twisted within a range from 90 to 360 degrees, and the product (Δnd) between the refractive index anisotropy (Δn) of the rod-shaped liquid crystalline molecule and the cell gap (d) falls within a range from 300 to 1500 nm. Optical compensation films used in STN-mode liquid crystal display devices are described in Japanese Patent Application Laid-Open No. 2000-105316.

(VA-mode Liquid Crystal Display Devices)

The cellulose acylate film according to the embodiment can be used as an optical compensation film or a support of the optical compensation film in a VA-mode liquid crystal display device having a VA (Vertical Alignment)-mode liquid crystal cell. The VA-mode liquid crystal display device may be of such an orientation division type as described in Japanese Patent Application Laid-Open No. 10-123576.

(IPS-mode Liquid Crystal Display Devices and ECB-mode Liquid Crystal Display Devices)

The cellulose acylate film according to the embodiment is particularly advantageously used as an optical compensation film, as a support of the optical compensation film or as a protective film of the polarizing plate in an IPS-mode liquid crystal display device having an IPS (In Plane Switching)-mode liquid crystal cell and an ECB (Electrically Controlled Birefringence)-mode liquid crystal display device having an ECB-mode liquid crystal cell. In these modes, the liquid crystal material is oriented approximately in parallel to each other at the time of black display, and under a condition of no applied voltage, the liquid crystalline molecules are oriented in parallel to the substrate face to give black display.

(OCB-mode Liquid Crystal Display Devices and HAN-mode Liquid Crystal Display Devices)

The cellulose acylate film according to the embodiment is also advantageously used as a support of the optical compensation film in an OCB (Optically Compensated Bend)-mode liquid crystal display device having an OCB-mode liquid crystal cell or in a HAN (Hybrid Aligned Nematic)-mode liquid crystal display device having a HAN-mode liquid crystal cell. It is preferable that the optical compensation film used in the optical compensation film in an OCB-mode liquid crystal display device or in a HAN-mode liquid-crystal display device has the direction of minimum absolute retardation of the optical compensation film neither within the plane nor in the normal direction of the optical compensatory film. The optical properties of the optical compensation film used in an OCB-mode liquid crystal display device or in a HAN-mode liquid crystal display device are determined by the optical properties of the optically anisotropic layer, the optical properties of the support and the configuration of the optically anisotropic layer and the support of the film. The optical compensation film used in an OCB-mode liquid crystal display device or a HAN-mode liquid crystal display device is described in Japanese Patent Application Laid-Open No. 9-197397, and additionally, in the paper by Mori et al. (Jpn. J. Appl. Phys., Vol. 38 (1999), p. 2837).

(Reflective Liquid Crystal Display Devices)

The cellulose acylate film according to the embodiment is advantageously used as an optical compensation film of a TN-mode, STN-mode, HAN-mode or GH(guest-host)-mode reflective liquid crystal display device.

These display modes have long been well known. The TN-mode reflective liquid crystal display device is described in Japanese Patent Application Laid-Open No. 10-123478, Pamphlet of International Publication No. WO 98/48320 and Japanese Patent No. 3022477. The optical compensation film used in the reflective liquid crystal display device is described in Pamphlet of International Publication No. WO 00/65384.

(Other Liquid-crystal Display Devices)

The cellulose acylate film according to the embodiment is also advantageously used as a support of the optical compensation film in an ASM(axially symmetric aligned microcell)-mode liquid crystal display device having an ASM-mode liquid crystal cell. The ASM-mode liquid crystal cell is characterized in that the cell thickness is held by a position-adjustable resin spacer. The other properties of the cell are the same as those of the TN-mode liquid crystal cell. The ASM-mode liquid crystal cell and the ASM-mode liquid crystal display device are described in the paper by Kume et al. (Kume et al., SID 98 Digest 1089 (1998)).

<Hard Coat Film, Anti-glare Film and Antireflection Film>

The cellulose acylate film according to the embodiment may be applied to a hard coat film, an anti-glare film and an antireflection film, as the case may be. For the purpose of improving the visibility of flat panel displays such as LCD (Liquid Crystal Display), PDP (Plasma Display Panel), CRT (Cathode Ray Tube) and EL (Electroluminescence) displays, one side or both sides of the cellulose acylate film according to the embodiment of the present invention may be provided with any of or all of a hard coat layer, an anti-glare layer and an antireflection layer. Preferable embodiments as such an anti-glare film and an antireflection film are described in detail in Japanese Patent Application Laid-Open No. 2001-1745 (issued on Mar. 15, 2001, Japan Institute of Invention and Innovation), pp. 54 to 57, and such embodiments may be preferably applied to the cellulose acylate film according to the embodiment.

### EXAMPLES

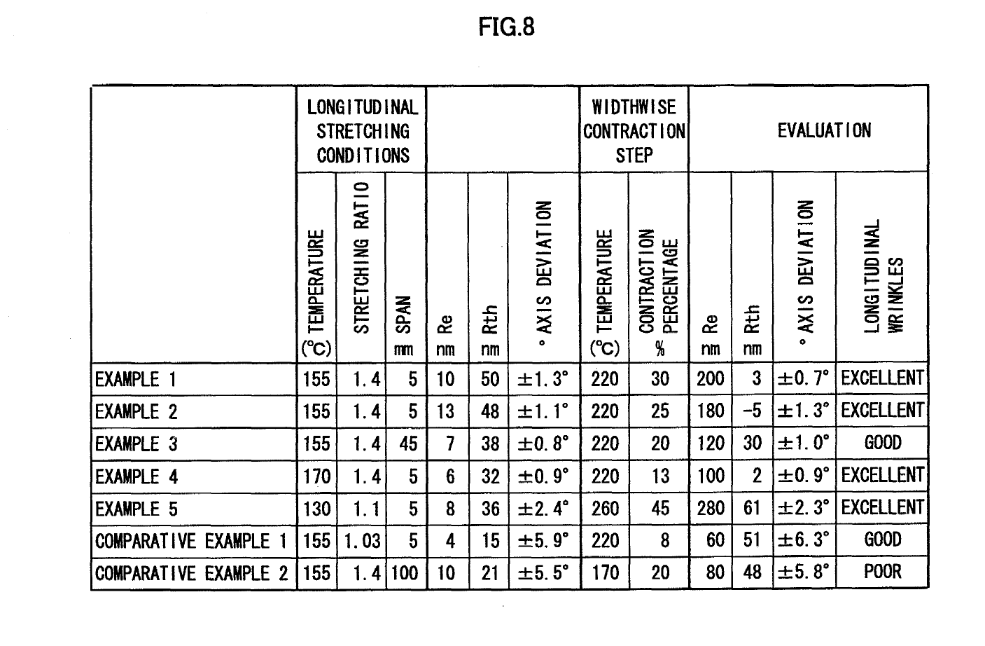

As an unstretched film, Fujitac film (thickness: 80 μm, Tg: 140° C., Tc: 195° C.) manufactured by Fujifilm Corporation was used. The unstretched film was subjected to a longitudinal stretching treatment and a heat treatment under the longitudinal stretching conditions and the heat treatment conditions shown in FIG. 8 to yield film products.

The table of FIG. 8 collectively lists the longitudinal stretching conditions, the film heating conditions, the widthwise contraction conditions and the evaluation (Re, Rth) of the produced stretched cellulose triacetate films for Examples 1 to 5 according to the embodiment and for Comparative Examples 1 and 2.

In FIG. 8, “span” means the surface-to-surface separation of a pair of stretching rollers, and “longitudinal wrinkles” means stripe-like wrinkles generated in the flow direction by the widthwise undulation, as seen on a corrugated plate, caused by film stretching. The wrinkle evaluation of the “longitudinal wrinkles” was conducted by visually observing a stretched portion. Evaluation was conducted on the basis of the following three grades: Excellent: Absolutely no wrinkles are found; Good: A small number of wrinkles are found, but no unevenness is found in the optical properties of the film; Poor: Wrinkles are generated and unevenness is caused in the optical properties of the film.

Examples 1 to 5 are the cases where all of the longitudinal stretching conditions, the film heating conditions and the widthwise contraction conditions listed in FIG. 8 are satisfied.

Comparative Example 1 is a case where the condition that the lower limit of 1.05 of the longitudinal stretching ratio, as an essential condition according to the embodiment, is not satisfied. Comparative Example 2 is a case where the condition that the upper limit of 50 mm of the surface-to-surface separation between the two rollers, as an essential condition according to the embodiment, is not satisfied.

Consequently, Examples 1 to 5 attained an Re value equal to or larger than 100 nm, namely, the target Re value according to this embodiment. Moreover, Examples 1 to 5 all satisfy the target relation Rth<Re/2 according to the embodiment as a result of a calculation based on the relation between Re and Rth shown in FIG. 8.

On the contrary, the Re values of Comparative Examples 1 and 2 were 60 nm and 80 nm, respectively, not to attain an Re value equal to or larger than 100 nm, namely, the target Re value according to the embodiment. Additionally, Comparative Examples 1 and 2 did not satisfy the relation Rth<Re×0.5.

What is claimed is:

1. A method for producing a cellulose acylate film comprising:
forming an unstretched cellulose acylate film;
stretching the unstretched cellulose acylate film by a ratio ranging from 1.05 to 1.6 in a longitudinal direction (MD) by using at least two rollers having a surface-to-surface separation ranging from 2 to 50 mm therebetween and being different in circumferential velocity; and
contracting in a widthwise direction (TD) the cellulose acylate film stretched in the longitudinal direction, by heating the cellulose acylate film to a temperature ranging from Tc to Tc+80° C. under conditions that widthwise ends of the cellulose acylate film are gripped.

2. The method for producing a cellulose acylate film according to claim 1, wherein
the stretching in the longitudinal direction (MD) is conducted at a film temperature ranging from Tg−50° C. to Tg+50° C.

3. A cellulose acylate film produced by the method according to claim 1.

4. The cellulose acylate film according to claim 3, wherein
in-plane retardation Re of the cellulose acylate film is 100 to 300 nm,
thicknesswise retardation Rth is Re×0.5 or less, and
slow axis deviation is ±5° or less in relation to the widthwise direction (TD).

5. The method for producing a cellulose acylate film according to claim 1, wherein
in-plane retardation Re and thicknesswise retardation Rth of the cellulose acylate film stretched in the longitudinal direction are 0 to 50 nm and 30 to 100 nm, respectively, and
slow axis deviation of the cellulose acylate film contracted in the widthwise direction (TD) is +5° or less in relation to the widthwise direction (TD).

6. A cellulose acylate film produced by the method according to claim 5.

7. The cellulose acylate film according to claim 6, wherein
in-plane retardation Re of the cellulose acylate film is 100 to 300 nm,
thicknesswise retardation Rth is Re×0.5 or less, and
slow axis deviation is ±5° or less in relation to the widthwise direction (TD).

8. The method for producing a cellulose acylate film according to claim 5, wherein
the stretching in the longitudinal direction (MD) is conducted at a film temperature ranging from Tg−50° C. to Tg+50° C.

9. A cellulose acylate film produced by the method according to claim 8.

10. The cellulose acylate film according to claim 9, wherein
in-plane retardation Re of the cellulose acylate film is 100 to 300 nm,
thicknesswise retardation Rth is Re×0.5 or less, and
slow axis deviation is ±5° or less in relation to the widthwise direction (TD).

11. An optical film in which the cellulose acylate film according to claim 10 is used.
